(19) United States
(12) Patent Application Publication
(10) Pub. No.: US 2021/0097790 A1
(43) Pub. Date: Apr. 1, 2021

(54) System and Method for Secured Cockpit Door

(71) Applicant: Michael T. Diep, Fountain Valley, CA (US)

(72) Inventor: Michael T. Diep, Fountain Valley, CA (US)

(21) Appl. No.: 16/583,254

(22) Filed: Sep. 26, 2019

(51) Int. Cl. G07C 9/00; G06K 9/00; B64C 1/14; B64D 45/00

(52) U.S. Cl. CPC G07C 9/00158; G06K 9/00255; G06K 9/00288; G06K 9/00013; H04N 5/2253; G06K 9/00892; B64C 1/1469; B64D 45/0018; G06K 9/00087

(57) ABSTRACT

A system of a secured cockpit door comprises a digital camera that comprises a digital optical sensor, a fingerprint scanner that comprises a glass top and a digital optical sensor, a biometrics processor, an identification verification processor, a database of pre-encoded authorized facial feature maps and authorized fingerprint maps, an electrochemical pad comprises an array of electrochemical sensors, a breathalyzer, and an ethanol concentration level processor.

### FIELD OF THE INVENTION

The present invention is directed generally to a system and method of securing an airplane cockpit door, using advanced security technologies and artificial intelligence technologies.

### BACKGROUND OF THE INVENTION

After Sep. 11, 2001, attacks, where hijackers breached commercial airplanes' cockpits, crashed the planes to buildings, and killed thousands, cockpit doors have been redesigned to prevent breaches. Fortified cockpit doors that can cost more than $20,000 replace prior flimsier ones that close with a latch or a key.

Since the September 11 attacks, pilots and flight attendants no longer have keys to open the cockpit door, which locks automatically and remains locked during flight. Access to the cockpit is controlled from the cockpit, with only a limited option for outside override. Access can be requested via a keypad outside the cockpit door by the flight crew, and a buzzer then sounds in the cockpit to alert the pilot and co-pilot, who can verify the requesting crew member through video surveillance system, and switches the door control inside the cockpit to unlock the door. Without an access code and the pilots' explicit permission, the flight crew or anyone else cannot enter the cockpit from the outside.

If the pilots become incapacitated or no response from the cockpit for a request to open the door, the flight crew can trigger an emergency access entry system by entering an override code on the keypad, which sets off a 30-second alert with sounds and lights in the cockpit that the door will be opened shortly. If there's no response from the cockpit by the end of the alert, the door automatically unlocks for five seconds and can be opened from outside.

If the pilots have any concerns, they have the capability of keeping the door in a locked position even if the emergency code is triggered. The door control toggle switch usually has three positions: unlock, normal and lock. To keep the door locked despite the emergency code, the pilots would select the “lock” option of the toggle switch. Where the “lock” option is selected, the outside keypad is then disabled for five to 20 minutes or until the pilot decides to unlock the door.

In case of an electrical supply failure, the cockpit door is automatically unlocked. Although the above cockpit door security system prevents unauthorized entry, it does nothing to prevent rogue or temporarily incapacitated pilots. As airplane design increasingly makes flights safer, the most common cause of recent airplane crashes is pilots' human errors. Pilots make mistakes in flight due to a variety of reasons, such as illness, medication, stress, alcohol, fatigue and emotion. It is common sense that sick or temporarily incapacitated pilots have no place in a cockpit. Being intoxicated could make a particular pilot more susceptible to spatial disorientation. Cold medication or common cold could cause a painful blocked eustachian tube, and the discomfort could cause pilots to make fatal mistakes.

For these reasons, in addition to current security features, it is desirable to have a cockpit door that would stop an incapacitated pilot from entering the cockpit.

### OBJECT OF THE INVENTION

Accordingly, it is an object of this invention to provide an innovative cockpit door security system to prevent unauthorized entry.

It is an object of the invention to provide an innovative cockpit door security system that incorporates facial recognition camera to recognize authorized persons' facial identification.

It is an object of the invention to provide an innovative cockpit door security system that incorporate fingerprint scanner to identify authorized persons' identification.

It is an object of the invention to provide an innovative cockpit door security system that incorporates a breathalyzer to detect and prevent intoxicated persons from entering the cockpit.

It is an object of the invention to provide an innovative cockpit door security system that incorporates an alcohol detection device alternative to a breathalyzer.

It is an object of the invention to provide an innovative cockpit door security system that incorporates other incapacitated substance detection device.

### SUMMARY OF INVENTION

A system of a secured cockpit door comprises a digital camera that comprises a digital optical sensor, a fingerprint scanner that comprises a glass top and a digital optical sensor, a biometrics processor, an identification verification processor, a database of pre-encoded authorized facial feature maps and authorized fingerprint maps, an electrochemical pad comprises an array of electrochemical sensors, a breathalyzer, and an ethanol concentration level processor.

In one embodiment of this invention, the digital camera is disposed about the center of said cockpit door.

In another embodiment of this invention, the fingerprint scanner and the electrochemical pad are disposed adjacently and about the center of the cockpit door.

In yet another embodiment of this invention, the breathalyzer is disposed below the fingerprint scanner and the electrochemical pad, and about the center of the cockpit door.

In one embodiment of this invention, the digital camera is adjustable within an elongated oval slot that is disposed about the center of the cockpit door.

A method of securing cockpit door comprises providing a digital camera that comprises a digital optical sensor; providing a fingerprint scanner that comprises a glass top and a digital optical sensor; providing a biometrics processor; providing an identification verification processor; providing a database of pre-encoded authorized facial feature maps and authorized fingerprint maps; providing an electrochemical pad comprises an array of electrochemical sensors; providing a breathalyzer; providing an ethanol concentration level processor; requiring an incomer to show the incomer's face to the digital camera; requiring an incomer to put the incomer's fingers on the fingerprint scanner; and requiring an incomer to put the incomer's fingers on the electrochemical pad.

In one embodiment of this invention, the method requires an incomer to show the incomer's face to the digital camera, put the incomer's fingers on the fingerprint scanner, and put the incomer's fingers on the electrochemical pad simultaneously.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 depicts a perspective view of an embodiment of the current invention, comprising a facial recognition camera, a fingerprint scanner, a substance detection pad, and a breathalyzer.

FIG. 2 is a flowchart of an exemplary facial identification verification process.

FIG. 3 is an illustration of an embodiment of a fingerprint scanner.

FIG. 4 is a flowchart of an exemplary fingerprint verification process.

FIG. 5 depicts an exemplary substance detection pad.

FIG. 6 illustrates the working principle of an exemplary electrochemical cell as a component of a substance detection pad.

FIG. 7 is a flowchart of an exemplary substance detection process.

FIG. 8 illustrates an embodiment that combines facial verification, fingerprint verification, and substance detection processes.

FIG. 9 depicts an embodiment of smart height adjustable digital camera.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more problems of current cockpit door security system. More specifically, the present invention is directed to a system and method for detecting unauthorized or intoxicated persons from opening the door.

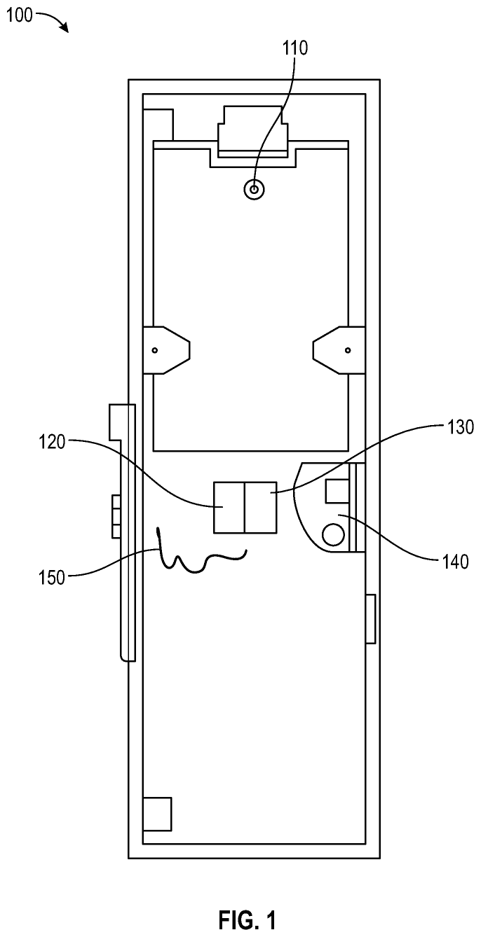

FIG. 1 illustrates an embodiment 100 of the current invention that comprises a facial recognition camera 110, a fingerprint scanner 120, a substance detection transdermal pad 130, or a breathalyzer 140. It is appreciated that each security feature can be customized to achieve the most secured system, but flexible enough to be adapted to different settings, environments, requirements, etc.

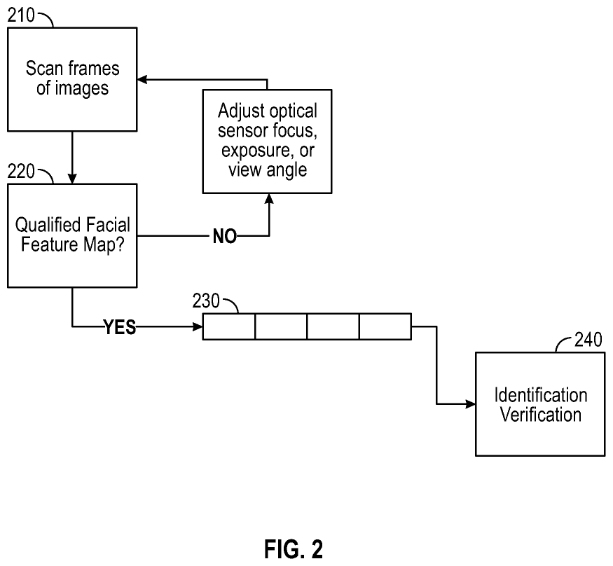

In one embodiment, a pilot who wants to enter the cockpit is required to face camera 110 to initiate a facial identification process. An embodiment of the facial identification process is depicted in FIG. 2. Camera 110's optical sensor component 210 frequently scans its front view for a facial image. Each frame of the image data is transmitted to and processed by a facial feature map component 220 of a central processing component secured inside the cockpit where the facial features are mapped using facial biometrics learned by the system. Biometrics are measures of different features of a face like eyes, nose, mouth, ears, their sizes, the distances between them, the contour of the cheeks, the nose, etc. Once the facial feature map is completed, it is queued in a queue 230. An identification verification component 240 monitors the queue 230, and when it detects the presence of a facial feature map, it de-queues the facial feature map in a first in first out order, and compares them with that of certain authorized persons'. The authorized persons' facial feature maps are pre-encoded and stored in a database that can be disposed locally inside the cockpit or remotely on a wireless network. It is appreciated that these information are encrypted to prevent hacking like a man-in-the-middle attack. Once an authorized identification is found, an unlock command is sent to a door lock component 140 to unlock the door, and an entry is allowed.

If the frame of facial image does not yield a qualified facial feature map, the system commands camera 110 to adjust its focus, exposure, or view angle to obtain a better suitable frames of image. Once a qualified feature map is produced, the system's identification component is activated to compare the qualified feature map with the authorized persons' feature maps, which are stored in a database. It is appreciated that obtaining frames of images and identification verification components are running in parallel and communicating via a producer-consumer architecture, where frames of images are obtained and put in a queue, and the identification verification component, comprising the feature map builder component, de-queues the frames for processing.

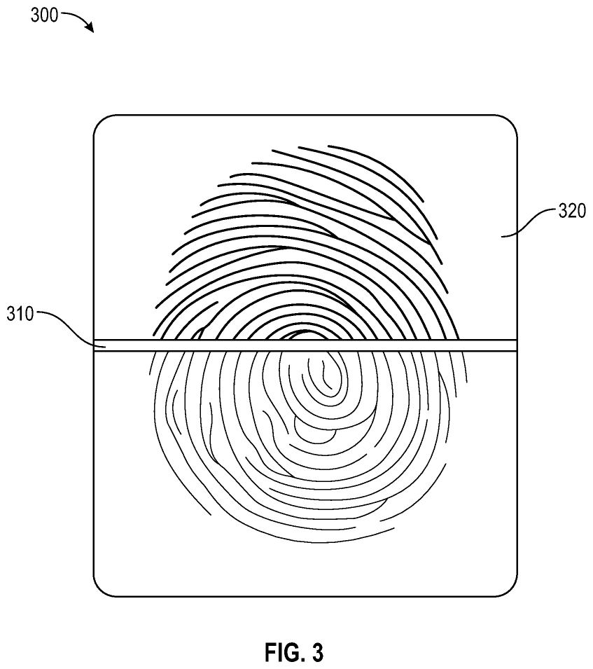

FIG. 3 depicts an embodiment 300 of the current invention's fingerprint scanner pad, which comprises a glass top 310 and an optical sensor 320, not shown, to capture a person's fingerprint image. Before being allowed to enter the cockpit, a pilot is required to put his index finger palm-down on the glass top 310, and let the optical sensor 320 captures the image of his fingerprint. Every fingerprint has a unique pattern of ridges and valleys that make up a unique biometrics of a person's fingerprint. A fingerprint biometrics consists of the pattern of ridges and valleys, their shapes, and their distances among themselves. Similar to the disclosed facial identification process above, once a fingerprint map is computed and encoded, it is queued in a queue for the identification verification component to process.

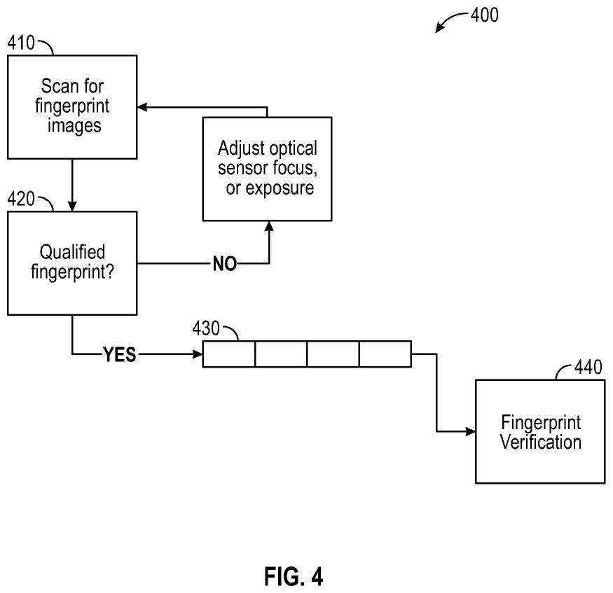

FIG. 4 illustrates an embodiment 400 of the current invention's fingerprint verification process. In this embodiment, an optical sensor component 410 scans and captures a fingerprint image that is placed on the glass top of the fingerprint scanner pad. This component tries to computer The identification verification component monitors the queue, and when it detects the presence of a fingerprint map, it de-queues and compares the fingerprint map with certain authorized persons' fingerprint maps, stored in a database. It is appreciated that the fingerprint maps database can be disposed in the cockpit or remotely on a wireless network. It is also appreciated that, in one embodiment, one identification verification component can be configured to process both facial and fingerprint identification. If the de-queued fingerprint map has a match in the database, an unlock command is sent to a door lock component 140, as disclosed above, to unlock the door, and an entry is allowed.

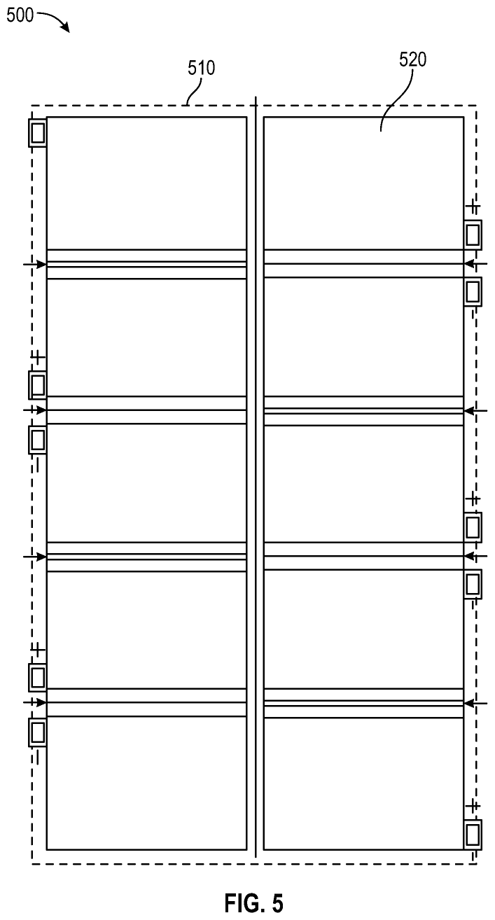

FIG. 5 illustrates an embodiment 500 of the current invention's substance detection pad. The detection pad 500 comprises electrochemical sensor made up of electrochemical cells 420 that can generates electrical energy as a specific substance comes in contact with the electrochemical cells and causes a specific chemical reaction. The detection pad 500 further comprises a cover fabric 510 that protects the integrity of the cells and the chemical reaction. For an alcohol test, a pilot adheres a patch of hyperhidrosis induced drug, such as Pilocarpine, Acetaminophen, etc., to the back of his hand. After a short prescribed time, the pilot put his finger or palm on the substance detection pad 500, which will absorb the pilot's sweat, and/or the vapor thereof, on his palm or finger. The array of electrochemical cells under the pad 510 reacts to the ethanol vapor in the sweat, and produces a continuous current signal proportional to ethanol concentration. As a result, an ethanol concentration or level number is produced by the sensors. The airline can pre-define an allowed level of ethanol concentration that is safe for flying its airplanes. If the pilot's ethanol level is at or below the pre-defined safe level, a unlock command is sent to the door lock component 140, disclosed above, to unlock the cockpit door, and an entry is allowed.

This innovative method of detecting ethanol level is not bodily invasive. The hyperhidrosis-induced patch employs non-invasive transdermal delivery technology that has been proven and advanced steadily in the modern time. The electrochemical sensor pad detects ethanol vapor on the surface of a person's skin. It is appreciated that not only ethanol level can be detected using this method, but other intoxicating substances can be too. Different intoxicating drugs can be detected by configuring the electrochemical cells 520 to detect the particular drug.

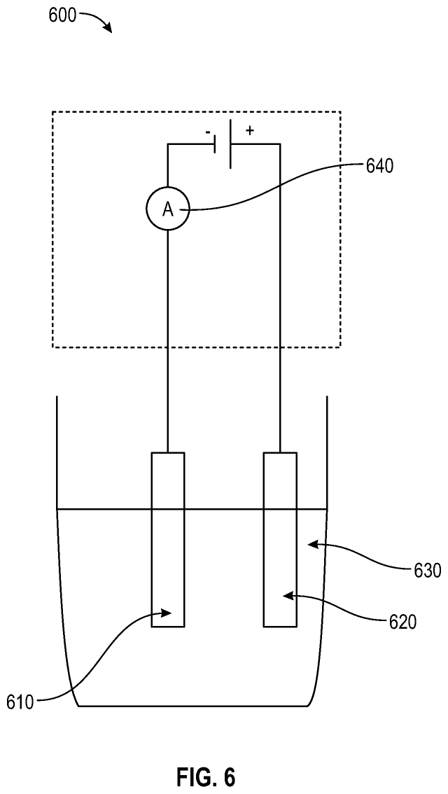

FIG. 6 illustrates an exemplary embodiment 600 of the current invention's electrochemical sensor cell. The basic components of an electrochemical sensor cell are a working (sensing) electrode, a counter electrode, and an ion conductor in between them. When vapor of interested substance such as ethanol comes in contact with the working electrode 610, a chemical reaction of the ethanol and host chemical will occur on the working electrode. This chemical reaction generates protons and electrons. Protons flow toward the counter electrode 620 through the ion conductor 630. In addition, generated electrons move to the counter electrode through the external wiring and through an electrical digital meter 640. The electrical digital meter reads the electricity current level, and converts the data to a digital format so that computer software can accept and process it.

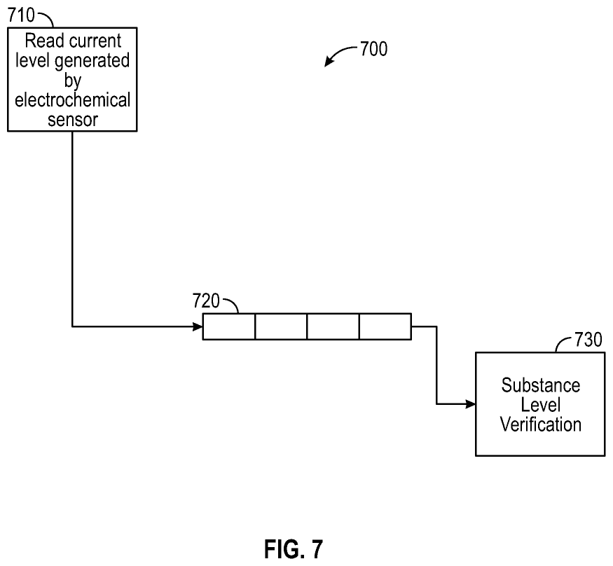

FIG. 7 illustrates an embodiment 700 of the current invention's substance detection process working in conjunction with the electrochemical detection pad and sensors disclosed above in FIGS. 6 and 7. In this process, an electrical digital meter component 710 reads electricity current level generated by the electrochemical detection pad, converts the reading to a digital format, and queues the data in a queue 720. This process further comprises a verification component 730 that runs on a different thread and monitors the queue 720. When the verification component 730 detects a data item in the queue 720, it de-queues the data items, processes the data, and compares the substance level detected with the allowable level pre-stored in a database inside the cockpit or on a wireless network.

Alternatively, for reasons the pilot chooses not to apply the hyperhidrosis-induced patch, s/he can use the breathalyzer 150 that is built into the cockpit door, as disclosed in FIG. 1, to test his ethanol level. The pilot exhales a long breath into the mouthpiece of the breathalyzer 150. The electrochemical sensor of the breathalyzer 150 senses and analyzes the ethanol vapor, if any, in the breath, and produces an ethanol concentration number. The central processing component compares this ethanol concentration number with a pre-defined number. If the pilot's ethanol concentration number is at or below the pre-defined number, an unlock command is sent to the door lock component 140 to unlock the cockpit door, and an entry is allowed.

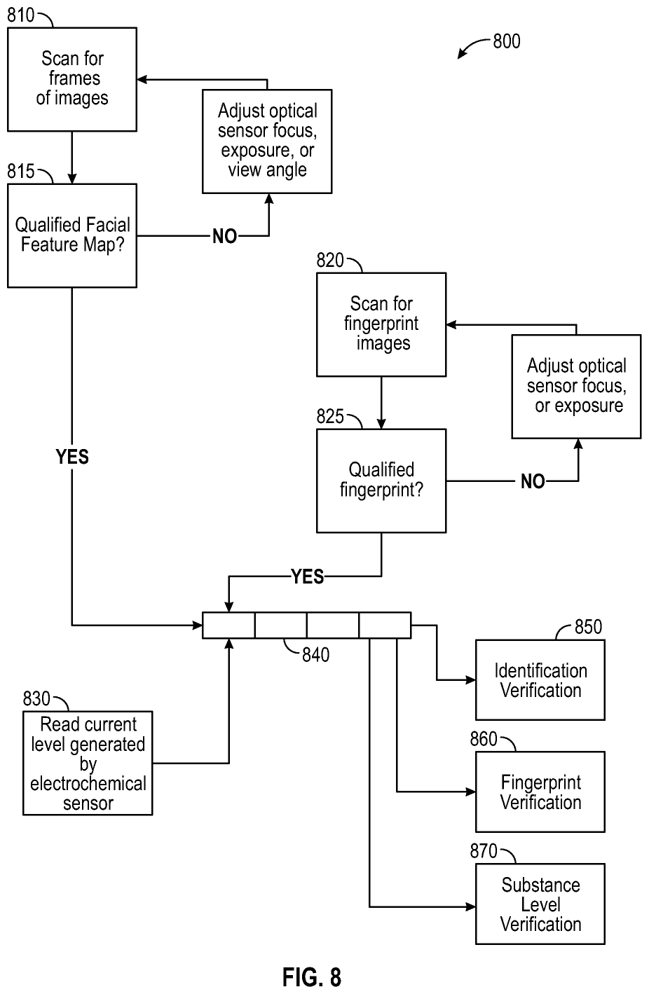

In one embodiment 800 as illustrated in FIG. 8, all of the above disclosed verification components, facial identification, fingerprint identification, and ethanol level detection, are employed. This embodiment 800 comprises an optical sensor component 810 that scans and captures images, and sends images to image processor component 815 that processes and computes the image's facial biometrics map, and queues the biometrics data in queue 840. The embodiment 800 further comprises fingerprint optical sensor component 820 that scans and captures fingerprint images. Then, fingerprint image processor component 825 processes and computes a fingerprint biometrics map, and queues the biometrics data in queue 840. The embodiment 800 further comprises a substance detection sensor component 830 that reads electricity current level produced by the chemical reaction between the detected substance and the host chemical, and coverts the information to digital data, and queues the data in the queue 840. This queue 840 is monitored by three processes, facial identification process, fingerprint identification process, and substance level verification process. Each verification process de-queues the data it is assigned to process, and leaves other types of data for other processes. Each verification process further comprises a comparison step where the de-queued and processed data is compared with pre-stored data in a database. The resulting output of each process is aggregated according to a pre-defined rule that is pre-set and pre-stored in the database, and the aggregate result will be compared with a pre-defined standard that is stored in the database. The outcome of this comparison will determine whether the cockpit door will be unlocked, and an entry is allowed.

It is appreciated that in another embodiment, two of the verification methods are employed. Simultaneous fingerprint verification and substance detection can be configured and required, so that the security system can determine the identity of the person who is taking the substance test. In this configuration, a pilot must place his entire hand with palm and fingers on the fingerprint/substance detection pad. The system will process his fingerprint and ethanol level simultaneously.

It is also appreciated that an embodiment can be configured to check a pilot one time at the commencement of a flight. Once validated, especially, his ethanol level, his flight credential is valid for the entire flight. That is, he does not need to re-check his ethanol level every time he exits and enters the cockpit during the flight. In other embodiments, the system can be configured to have the pilot re-check his ethanol level every time he wants to enter the cockpit.

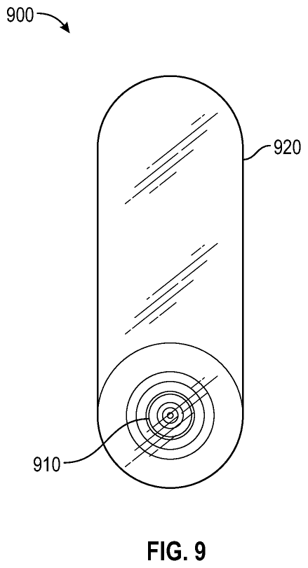

FIG. 9 illustrates another embodiment 900 of the current invention where digital camera 910 is disposed within a slot 920. The camera 910 is movable within the slot 920 and its movement is controlled by system with feedback data from the optical sensor. The slot 920 is disposed about the center of a cockpit door. When a pilot is tall, the optical sensor detects the height by images it receives. The optical sensor requests the system to move the camera 910 up or down the slot 920 until the optical sensor receives a qualified image. The optical sensor component then processes the qualified image, and computes and queues the image's biometrics map required for the verification process.

1. A system of a secured cockpit door comprising:
a) a digital camera that comprises a digital optical sensor; wherein said digital camera is automatically adjustable to an incomer's eyes within an elongated oval slot that is disposed about the center of said cockpit door;
b) a fingerprint scanner that comprises a glass top and a digital optical sensor;
c) a biometrics processor;
d) an identification verification processor;
e) a database of pre-encoded authorized facial feature maps and authorized fingerprint maps;
f) an electrochemical pad comprises an array of electrochemical sensors;
g) a breathalyzer;
h) an ethanol concentration level processor.

2. The system of claim 1 wherein said digital camera is disposed about the center of said cockpit door.

3. The system of claim 1 wherein said fingerprint scanner and said electrochemical pad are disposed adjacently and about the center of said cockpit door.

4. The system of claim 1 wherein said breathalyzer is disposed below said fingerprint scanner and said electrochemical pad, and about the center of said cockpit door.

5. The system of claim 1 wherein said digital camera is automatically adjustable to said incomer's face within said elongated oval slot.

6. A method of securing cockpit door comprising:
a) providing a digital camera that comprises a digital optical sensor; wherein said digital camera is automatically adjustable to an incomer's eyes within an elongated oval slot that is disposed about the center of said cockpit door;
b) providing a fingerprint scanner that comprises a glass top and a digital optical sensor;
c) providing a biometrics processor;
d) providing an identification verification processor;
e) providing a database of pre-encoded authorized facial feature maps and authorized fingerprint maps;
f) providing an electrochemical pad comprises an array of electrochemical sensors;
g) providing a breathalyzer;
h) providing an ethanol concentration level processor;
i) requiring an incomer to show said incomer's face to said digital camera;
j) requiring an incomer to put said incomer's fingers on said fingerprint scanner;
k) requiring an incomer to put said incomer's fingers on said electrochemical pad.

7. The method of claim 6 wherein requiring an incomer to show said incomer's face to said digital camera, put said incomer's fingers on said fingerprint scanner, and put said incomer's fingers on said electrochemical pad simultaneously.

8. The method of claim 6 wherein said digital camera is automatically adjustable to an incomer's face within said elongated oval slot.
